(19) United States
(12) Patent Application Publication
(10) Pub. No.: US 2019/0158378 A1
(43) Pub. Date: May 23, 2019

(54) AVIONICS TEST SERVER FOR ON-SITE TESTING OF IN-FLIGHT ENTERTAINMENT SERVERS

(71) Applicant: HAVELSAN HAVA ELEKTRONIK SANAYI VE TICARET ANONIM SIRKETI, Ankara (TR)

(72) Inventors: Mehmet AKIN, Ankara (TR); Mustafa Oguzkaan YÜKSELENTÜRK, Ankara (TR)

(73) Assignee: Havelsan Hava Elektronik Sanayi ve Ticaret Anonim Sirketi, Ankara (TR)

(21) Appl. No.: 16/091,131

(22) PCT Filed: Dec. 29, 2016
(86) PCT No.: PCT/TR2016/050566

§ 371 Date: Oct. 4, 2018

(30) Foreign Application Priority Data
Apr. 6, 2016 (TR) 2016/04477

(51) Int. Cl. H04L 12/26; H04L 29/08; H04L 29/06

(52) U.S. Cl. CPC H04L 43/50; H04L 69/18; H04L 67/12

(57) ABSTRACT

The invention relates to an easy-to-transport avionics test server for on-site (without removing from the plane) testing of IFE (In-Flight Entertainment) servers, which are components of in-flight entertainment systems, containing counterparts of all the interfaces on the IFE server, capable of generating all the signals the aircraft sends to the cabled IFE server and analyzing the responses.

### THE RELATED ART

The invention relates to an easy-to-transport avionics test server for on-site testing of IFE (In-Flight Entertainment) servers, which are components of in-flight entertainment systems, containing counterparts of all the interfaces on the IFE server, capable of generating all the signals the aircraft sends to the IFE server and analyzing the responses.

### THE PRIOR ART

Airline companies use in-flight entertainment systems to ensure passenger loyalty, increase confidence in the company's brand during flight, and create charm and difference in order to attract new passengers.

It is important for airline companies that the maintenance and control of the IFE servers in the in-flight entertainment systems are done quickly after the aircraft lands. In the prior art, in order to perform these controls, it is required to remove the IFE server from the plane and transport to the maintenance area. The test equipments used are stationary test mechanisms and consist of different devices.

It requires time and labour for removal and transportation of the IFE servers. This is an undesirable situation for airline companies, which causes the aircraft to stay on the ground for a long time. Considering that said control and maintenance operations are repeated after each flight, it is obvious that a significant amount of time is lost for this operation.

All of the above drawbacks indicate the need for equipment to shorten the time that aircrafts stay on the ground for maintenance and to perform on-site inspections of in-flight entertainment servers.

### BRIEF DESCRIPTION OF THE INVENTION

The present invention relates to an avionics test server for eliminating the above said drawbacks and bringing new technical advantages to the relevant technical field.

The main purpose of the invention is to ensure that the in-flight entertainment servers are tested on-site without removing from the plane, thus ensuring that maintenance and control operations are completed in a short time.

The avionics test server of the invention contains the counterparts of all interfaces in wired and wireless in-flight entertainment servers and it can generate all the signals sent by the aircraft and analyze the corresponding responses thanks to the included software. The test server can perform the functions of more than one device alone. The portable structure allows testing on the aircraft.

The avionics test server according to the invention can be used in the IFE server DO-160 tests, in the factory acceptance tests of the cards taken from the subcontractor and as the ground support equipment. With this server, malfunctions that may occur in avionics equipment can be easily detected and tested after the repair process. Aircraft maintenance and repair companies will be able to use the server according to the invention as ground support and malfunction detection equipment at their own facilities.

In order to achieve the above said purposes which would be understood better with the below given detailed description, the present invention relates to a portable avionics test server for on-site testing of in-flight entertainment servers, which are components of in-flight entertainment systems used on passenger aircrafts. Said avionics test server basically comprises:
a processor, to which all the components are connected, and which can control all the interfaces,
discrete signal switches generating “Weight on Wheels”, “Parkbrake Set”, “Door Closed”, “PA Amplifier” signals generated by the plane,
USB ports used for keyboard, mouse, USB memory connection,
Ethernet ports with 1 Gpbs speed used for testing high speed Ethernet lines,
ARINC 419 ports generating speed, altitude, latitude, longitude, location etc. data generated by the plane and transmitting the same to the unit to be tested,
ARINC 717 ports generating and receiving the ARINC 717 signals generated by the plane,
an RS-232 port for testing RS-232 signals,
an RS-485 port for testing RS-485 signals,
an RS-422 port for testing RS-422 signals,
analog audio ports for testing analog audio input/output ports.

### DETAILED DESCRIPTION OF THE INVENTION

In this detailed description, the novelty according to the invention is only disclosed for better understanding of the subject without forming any limiting effect.

On the avionics test server of the invention, counterparts of all of the interfaces found in wired and wireless in-flight entertainment servers are available, and with the software included therein, it is able to generate all the signals the aircraft sends to the in-flight entertainment servers, analyze the incoming responses and report the results.

The avionics test server according to the invention comprises:
a processor, to which all the components are connected, and which can control all the interfaces,
discrete signal switches generating “Weight on Wheels”, “Parkbrake Set”, “Door Closed”, “PA Amplifier” signals generated by the plane,
USB ports used for keyboard, mouse, USB memory connection,
Ethernet ports with 1 Gpbs speed used for testing high speed Ethernet lines,
ARINC 419 ports generating speed, altitude, latitude, longitude, location etc. data generated by the plane and transmitting the same to the unit to be tested,
ARINC 717 ports generating and receiving the ARINC 717 signals generated by the plane,
an RS-232 port for testing RS-232 signals,
an RS-485 port for testing RS-485 signals,
an RS-422 port for testing RS-422 signals,
Analog audio ports for testing analog audio input/output ports,
On/Off button.

The avionics test server of the present invention preferably comprises an Intel Atom N450 processor, an RS-232 port, an RS-485 port, an RS-422 port, seven Ethernet ports with 1 Gbps speed, 8 Rx/8 Tx ARINC 429 channels, 4 Rx/4 Tx 717 channels, 4 discrete signaling switches, 1 input/output audio channel and 2 USB 2.0 VGAs. The VGA interface allows screen connection to the server. Data can be transferred from USB using USB multiplexer.

Said Intel Atom N450 processor is connected to the ARINC-429/717 card, Ethernet switch card, power card and other components. In the server design, a 240 Gb or 600 Gb SSD memory storage is used. Thanks to SSD, the speed of the server is increased.

4 discrete signaling switches are found at the front side of the server. These discrete signaling switches are “Weight on Wheels”, “Parkbrake Set”, “Door Closed”, and “PA Amplifier”. In addition, 16 software configurable discrete input/output lines and a connector at which these lines are collected are found.

The avionics test server according to the invention has software and hardware capable of performing the functions of more than one device alone. Since Intel Atom N450 processor, Ethernet switch, Power supply, ARINC 429/417 card suitable with PC104+form factor are used in its production, a smaller portable device is provided. This allows the avionics test server to test the in-flight entertainment servers on board.

With this structure, the avionics test server can be used as a server in testing of all kinds of servers and devices having the interfaces found on the server, in laboratories of companies developing in-flight entertainment systems, and in different areas by changing the operating system.

The test operation with the avionics test server is performed as follows; The Avionic Test Server (ATS) cable is connected to the in-flight entertainment server. Afterwards, the avionics test server is opened and the ARINC-429 test software is started. At this moment, the avionics test server generates speed, altitude, latitude, longitude, outside temperature data by acting as the central control computer of the aircraft.

For example: it sends to the in-flight entertainment server, speed data by generating the speed data with the increasing rate of from 0 km/h to 800 km/h in each second. Meanwhile, the in-flight entertainment server sends the speed data it receives back to the avionics test server along with the time information. In the latter case, the time-rate parameters sent by the avionics test server and the time-rate parameters sent by the in-flight entertainment server are compared on a table. If data that are not identical to each other are found, the software reports the nonconformities by giving a warning. Similar data transmission and retrieval operations are also applied for altitude. Data starting from an altitude of 0 feet to an altitude of 30,000 feet are sent out with one second interval and the same procedure is repeated. If all of the parameters have been tested and the wrong or unsuitable signals are caught, the root cause analysis is performed by the avionics test server and the result screen shows which component the maintenance personnel should change.

1. A portable avionics test server for on-site testing of in-flight entertainment servers, which are components of in-flight entertainment systems used on passenger aircrafts, and it is characterized in that; it comprises:
a processor, to which all the components are connected, and which can control all the interfaces,
discrete signal switches generating “Weight on Wheels”, “Parkbrake Set”, “Door Closed”, “PA Amplifier” signals generated by the plane,
USB ports used for keyboard, mouse, USB memory connection,
Ethernet ports with 1 Gpbs speed used for testing high speed Ethernet lines,
ARINC 419 ports generating speed, altitude, latitude, longitude, location etc. data generated by the plane and transmitting the same to the unit to be tested,
ARINC 717 ports generating and receiving the ARINC 717 signals generated by the plane,
an RS-232 port for testing RS-232 signals,
an RS-485 port for testing RS-485 signals,
an RS-422 port for testing RS-422 signals,
analog audio ports for testing analog audio input/output ports.
